(19) United States
(12) Patent Application Publication
(10) Pub. No.: US 2004/0086837 A1
(43) Pub. Date: May 6, 2004

(54) Learning machine for brains development

(76) Inventor: Li-Chuan Huang, Taichung (TW)

Correspondence Address: Li-Chuan Huang, 58, MA YUAN WEST ST., TAICHUNG, TW

(21) Appl. No.: 10/412,370

(22) Filed: Apr. 9, 2003

(30) Foreign Application Priority Data
Nov. 4, 2002 (TW) 091204736

(51) Int. Cl. G09B 19/00

(52) U.S. Cl. 434/236

(57) ABSTRACT

A learning machine for brains development includes a main body, a control unit, a record unit, a play unit, an alarm clock device, a multi-stage timing device, and a display unit. Thus, the learning machine can develop the alpha wave and the theta wave in the user's brain during the sleeping period, thereby enhancing the memory learning effect of the user's brain. In addition, the learning machine can receive different teaching machines, such as the IC memory card, microphone, tape recorder, MP3, CD, DVD, computer, internet download or the like, thereby enhancing the diversity of the learning machine.

### BACKGROUND OF THE INVENTION

1. Field of the Invention

The present invention relates to a learning machine, and more particularly to a learning machine for brains development.

2. Description of the Related Art

A conventional learning machine is used at fifty minutes after the user sleeps or before the user wakes to play the same teaching contents successively. Thus, the conventional learning machine can be-used to develop the alpha wave and the theta wave in the user's brain during the sleeping period, so as to enhance the memory learning effect of the user's brain by playing the same teaching contents successively.

However, the conventional learning machine has the following disadvantages.

1. The user has to replay the same teaching contents manually, thereby causing inconvenience to the user.

2. The conventional learning machine primarily emphasizes the playing function without incorporating with other functions, thereby limiting the versatility of the conventional learning machine.

### SUMMARY OF THE INVENTION

The primary objective of the present invention is to provide a learning machine including a multi-stage timing device that can start the digital record unit automatically at a determined time interval, so that the user can learn the recorded contents successively.

Another objective of the present invention is to provide a learning machine including an input device that can receive different teaching machines, such as the IC memory card, microphone, tape recorder, MP3, CD, DVD, computer, internet download or the like, thereby enhancing the diversity of the learning machine.

A further objective of the present invention is to provide a learning machine that is provided with a volatile box containing aroma or the like to provide fragrance smell and to provide a peace and calm effect.

A further objective of the present invention is to provide a learning machine that can develop the alpha wave and the theta wave in the user's brain during the sleeping period, thereby enhancing the memory learning effect of the user's brain.

In accordance with the present invention, there is provided a learning machine, comprising:

a main body; and

a record unit mounted on the main body and including a record button, and a stage button, wherein:

the record button can be pressed to receive surrounding sound to perform a recording action; and

the stage button can be pressed to divide the recorded sound from the record button into multiple stages.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a learning machine in accordance with the preferred embodiment of the present invention;

FIG. 2 is a block diagram of the learning machine in accordance with the preferred embodiment of the present invention; and

FIG. 3 is a perspective practice view of the learning machine in accordance with the preferred embodiment of the present invention.

### DETAILED DESCRIPTION OF THE INVENTION

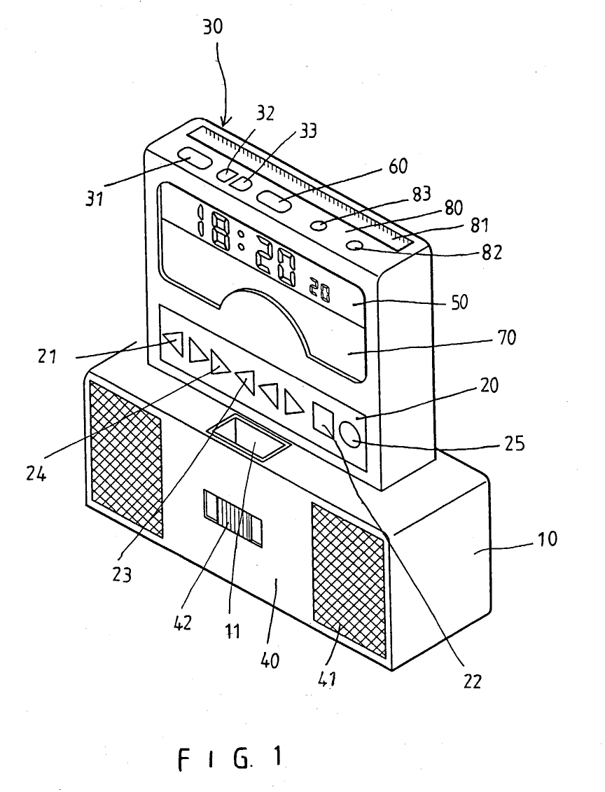

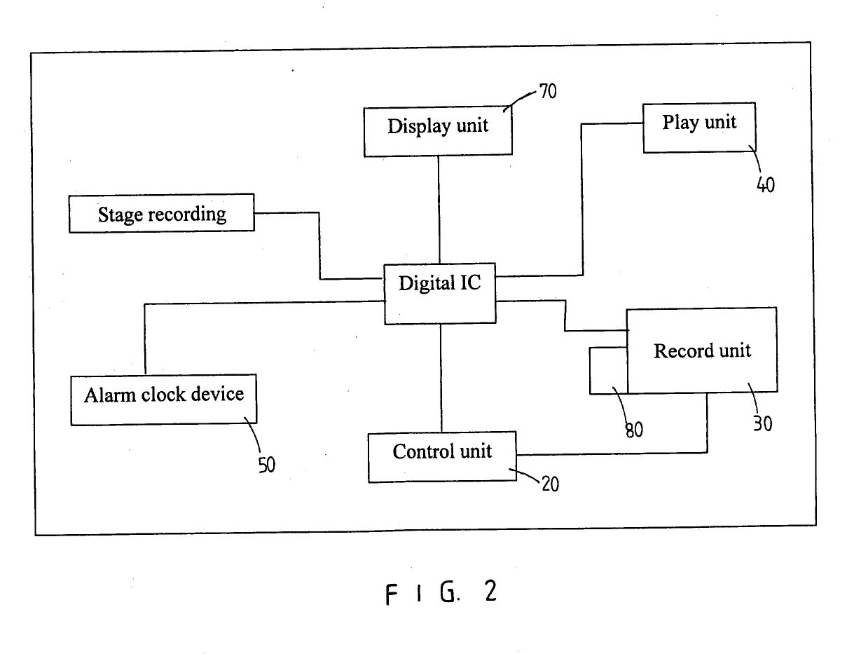

Referring to the drawings and initially to FIGS. 1 and 2, a learning machine for brains development in accordance with the preferred embodiment of the present invention comprises a main body 10, a control unit 20, a record unit 30, a play unit 40, an alarm clock device 50, a multi-stage timing device 60, and a display unit 70.

The main body 10 uses a digital IC structure. The main body 10 has inside provided with a volatile box 11 containing aroma or the like to provide fragrance smell.

The control unit 20 is mounted on the main body 10, and includes a play button 21, a stop button 22, a fast forward button 23, a rewind button 24, and a replay button 25.

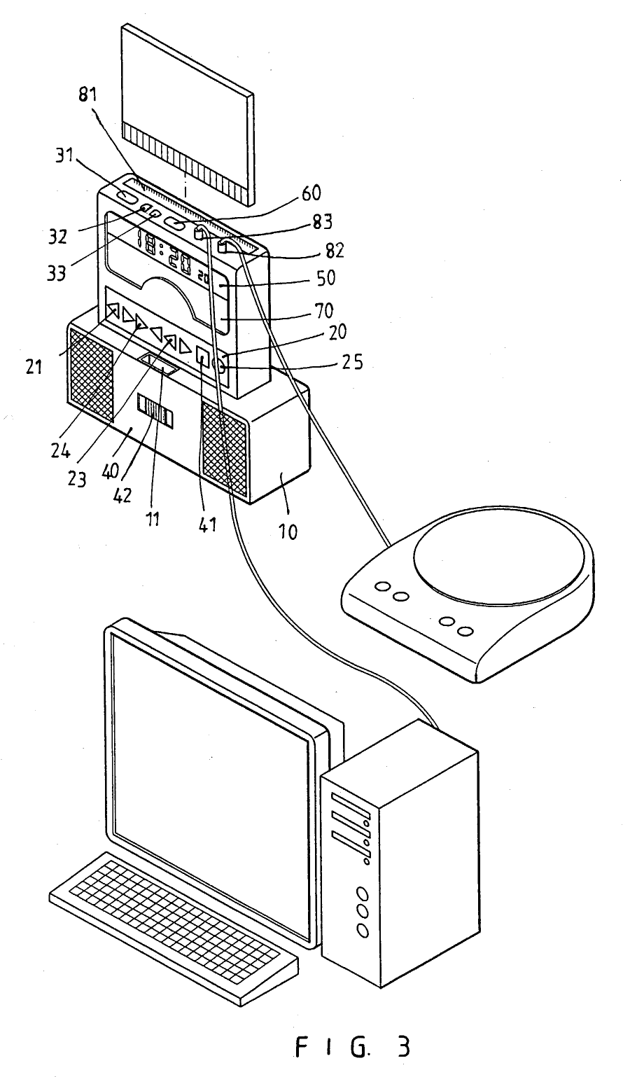

The record unit 30 is mounted on the main body 10, and includes a record button 31, a stage button 32, a minute button 33, and an input device 80. Preferably, the record unit 30 is a digital record device. The record button 31 can be pressed to receive the surrounding sound to perform the recording action. The stage button 32 can be pressed to divide the recorded sound from the record button 31 into multiple stages or hundreds of stages, and the optimum value of each stage is about one to six minutes. Thus, the record button 31 is used to control the contents to be recorded, and the stage button 32 and the minute button 33 are used to divide the recorded contents into one to six minutes per stage automatically, thereby facilitating the user learning the recorded contents stage by stage. The input device 80 includes an IC memory card slot 81, a sound source input 82, and a sound wave input 83. Thus, as shown in FIG. 3, the input device 80 can receive contents from different teaching machines, such as the IC memory card, microphone, tape recorder, MP3, CD, DVD, computer, internet download or the like.

The play unit 40 is mounted on the main body 10, and includes a speaker 41, and a volume button 42.

The alarm clock device 50 is mounted on the main body 10 to provide an alarm function.

The multi-stage timing device 60 is mounted on the main body 10, and has a multi-stage timing function, so that the recorded contents can be played at different time periods automatically.

The display unit 70 is mounted on the main body 10 can display the instant function of the learning machine, such as the time, the present state, the stage or the like.

In practice, as shown in FIG. 3, the input device 80 can receive surrounding sound from different teaching machines, such as the IC memory card, microphone, tape recorder, MP3, CD, DVD, computer, internet download or the like. Then, the input sound is recorded in the record unit 30. Then, the recorded sound can be played from the play unit 40 by control of the control unit 20.

Accordingly, the learning machine for brains development in accordance with the present invention has the following advantages.

1. The learning machine includes a multi-stage timing device 60 to start the digital record unit 30 automatically at a determined time interval, so that the user can learn the recorded contents successively.

2. The learning machine includes an input device 80 that can receive different teaching machines, such as the IC memory card, microphone, tape recorder, MP3, CD, DVD, computer, internet download or the like, thereby enhancing the diversity of the learning machine.

3. The learning machine is provided with a volatile box 11 containing aroma or the like to provide fragrance smell and to provide a peace and calm effect.

4. The learning machine can develop the alpha wave and the theta wave in the user's brain during the sleeping period, thereby enhancing the memory learning effect of the user's brain.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A learning machine, comprising:
a main body; and
a record unit mounted on the main body and including a record button, and a stage button, wherein:
the record button can be pressed to receive surrounding sound to perform a recording action; and
the stage button can be pressed to divide the recorded sound from the record button into multiple stages.

2. The learning machine in accordance with claim 1, wherein the record unit further includes an input device that can receive contents from different teaching machines, including the IC memory card, microphone, tape recorder, MP3, CD, DVD, computer, and internet download.

3. The learning machine in accordance with claim 2, wherein the input device includes an IC memory card slot, a sound source input, and a sound wave input.

4. The learning machine in accordance with claim 1, wherein the main body uses a digital IC structure.

5. The learning machine in accordance with claim 1, wherein the main body has inside provided with a volatile box containing aroma therein.

6. The learning machine in accordance with claim 1, wherein the record unit further includes a minute button co-operating with the stage button to divide the recorded contents into one to six minutes per stage automatically.

7. The learning machine in accordance with claim 1, further comprising a control unit mounted on the main body and including a play button, a stop button, a fast forward button, a rewind button, and a replay button.

8. The learning machine in accordance with claim 1, further comprising a play unit mounted on the main body and including a speaker, and a volume button.

9. The learning machine in accordance with claim 1 further comprising an alarm clock device mounted on the main body to provide an alarm function.

10. The learning machine in accordance with claim 1, further comprising a multi-stage timing device mounted on the main body and having a multi-stage timing function, so that the recorded contents can be played at different time periods automatically.

11. The learning machine in accordance with claim 1, further comprising a display unit mounted on the main body to display the instant function of the learning machine.
